(19) United States
(12) Patent Application Publication
(10) Pub. No.: US 2012/0034455 A1
(43) Pub. Date: Feb. 9, 2012

(54) POLYIMIDE FILM, METHOD FOR PRODUCING THE SAME, AND METAL-LAMINATED POLYIMIDE FILM

(76) Inventors: Naoyuki Matsumoto, Yamaguchi (JP); Hidenori Mii, Yamaguchi (JP); Takeshi Uekido, Yamaguchi (JP); Nobu Iizumi, Yamaguchi (JP); Keiichi Yanagida, Yamaguchi (JP); Eiji Masui, Yamaguchi (JP); Toshiyuki Nishino, Yamaguchi (JP); Takao Miyamoto, Yamaguchi (JP)

(21) Appl. No.: 13/264,492

(22) PCT Filed: Apr. 14, 2010
(86) PCT No.: PCT/JP2010/056714

§ 371 Date: Oct. 14, 2011

(30) Foreign Application Priority Data
Apr. 14, 2009 (JP) 2009-098199

(51) Int. Cl. B32B 15/08; B29C 55/02; B32B 27/08

(52) U.S. Cl. 428/336; 428/473.5; 264/134; 428/458

(57) ABSTRACT

The present invention provides a polyimide film having an anisotropic thermal expansion coefficient, and comprising a polyimide layer (b) and a polyimide layer (a) on one side or both sides of the polyimide layer (b), wherein
the polyimide layer (a) is a layer of a polyimide prepared from a monomer component comprising a diamine having the structure of the following formula (1):

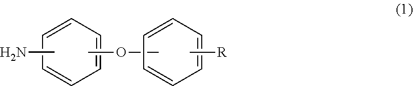

wherein
R represents a monovalent group selected from the groups listed as the following formula (2):

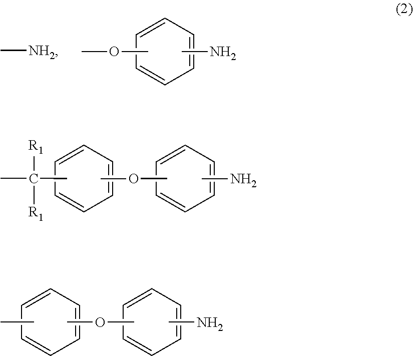

wherein
R₁ represents a hydrogen atom or a methyl group, and two R₁ groups may be the same as, or different from each other.

### TECHNICAL FIELD

The present invention relates to a polyimide film for use, for example, as a material for an electronic component such as a printed wiring board, a flexible printed circuit board, a TAB tape and a COF tape, and a material for a reinforced sheet, and the like, on which a metal layer having excellent adhesiveness in all directions may be formed; and a process for producing the same.

### BACKGROUND ART

A polyimide film has been used as an insulating member and a cover member for a wiring of an electrical/electronic component.

Patent Document 1 discloses a dimensionally-stable aromatic polyimide film, which is obtained from a solution of a polymer prepared by the polymerization of a biphenyltetracarboxylic acid and a phenylenediamine, and has an average thermal expansion coefficient between about 50° C. and about 300° C. within a range of from about 0.1×10⁻⁵ cm/cm/° C. to about 2.5×10⁻⁵ cm/cm/° C., a ratio (MD/TD) of thermal expansion coefficient in the length direction (MD direction) to thermal expansion coefficient in the width direction (TD direction) within a range of from about ⅕ to about 4, and a thermally dimensional stability, which refers to the percentage of dimensional change of the polyimide film, which is heated from normal temperature to 400° C. and maintained at 400° C. for 2 hours, relative to the dimension before the heat treatment, within a range of from 0% to about 0.3%.

Patent Document 2 discloses a polyimide film, which has a thermal expansion coefficient (αMD) in the machine-transport direction (MD) within a range of from 10 ppm/° C. to 20 ppm/° C. and a thermal expansion coefficient (αTD) in the width direction (TD) within a range of from 3 ppm/° C. to 10 ppm/° C.

Patent Document 3 discloses a continuous production process for a polyimide film in which the thermal expansion coefficient in the width direction is lower than the thermal expansion coefficient in the length direction, which comprises steps of:

flow-casting a solution of a polyimide precursor in a solvent on a support,

removing the solvent from the solution, thereby preparing a self-supporting film;

peeling the self-supporting film from the support;

stretching the self-supporting film in the width direction at an initial heating temperature of from 80° C. to 300° C.; and then

heating the film at a final heating temperature of from 350° C. to 580° C.

### CITATION LIST

### Patent Document

Patent Document 1: JP-A-S61-264028
Patent Document 2: JP-A-2005-314669
Patent Document 3: JP-A-2009-067042

### SUMMARY OF INVENTION

### Problems to be Solved by the Invention

As a fine-pitch wiring is formed in a wiring board, it is desired that a polyimide film has a thermal expansion coefficient close to that of a substrate member such as a glass substrate and an epoxy substrate, which is connected to a wiring board, and that of a chip member such as an IC chip, which is mounted on a wiring board. In addition, it is desired that a polyimide film has a thermal expansion coefficient along the direction of the metal wiring in the wiring board close to that of the metal layer.

Meanwhile, the formation of a metal wiring from the metal layer which is formed on a polyimide film, and the like are generally conducted in a roll-to-roll process. Another substrate and a chip member are mostly connected or mounted to a polyimide film along the TD direction. Accordingly, it is desired that a polyimide film has a thermal expansion coefficient in the MD direction which is close to that of a metal, and a thermal expansion coefficient in the TD direction which is close to that of another substrate and a chip member.

In general, the attempts have been made to produce polyimide films having different thermal expansion coefficients between in the MD direction and the TD direction by stretching the film in the length direction and/or in the width direction during the production of the polyimide film.

However, it have been found that a polyimide film, which is stretched during production and has different thermal expansion coefficients between in the MD direction and the TD direction, has an anisotropic adherence; specifically anisotropic adherence to a metal layer formed by a metallizing method.

An object of the present invention is to provide a polyimide film having an anisotropic thermal expansion coefficient and reduced anisotropy of adherence to a metal, and the like; and a process for producing such a polyimide film.

### Means for Solving the Problems

The first aspect of the present invention relates to a polyimide film having an anisotropic thermal expansion coefficient, and comprising a polyimide layer (b) and a polyimide layer (a) on one side or both sides of the polyimide layer (b), wherein

the polyimide layer (a) is a layer of a polyimide prepared from a monomer component comprising a diamine having the structure of the following formula (1):

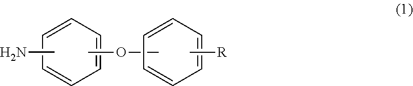

wherein
R represents a monovalent group selected from the groups listed as the following formula (2):

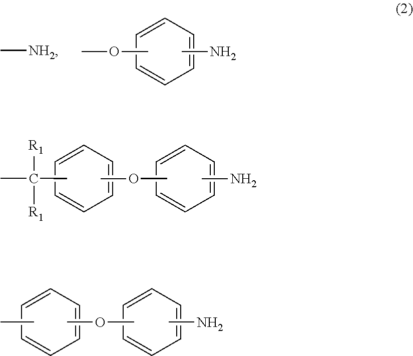

wherein
R₁ represents a hydrogen atom or a methyl group, and two R₁ groups may be the same as, or different from each other.

In the first aspect of the present invention, the polyimide film may be preferably prepared by

(i) coating a self-supporting film of a polyimide precursor solution (b), which is to be converted into the polyimide layer (b), with a polyimide precursor solution (a), which is to be converted into the polyimide layer (a); and then stretching or shrinking the film in at least one direction while heating it so that the polyimide film obtained has an anisotropic thermal expansion coefficient; or

(ii) forming a self-supporting film by co-extruding a polyimide precursor solution (b), which is to be converted into the polyimide layer (b), and a polyimide precursor solution (a), which is to be converted into the polyimide layer (a); and then stretching or shrinking the film in at least one direction while heating it so that the polyimide film obtained has an anisotropic thermal expansion coefficient.

The second aspect of the present invention relates to a metal-laminated polyimide film, comprising a polyimide film according to the first aspect of the present invention, and a metal layer which is laminated directly or via an adhesive layer on the surface of the polyimide layer (a) of the polyimide film.

The third aspect of the present invention relates to a process for producing a polyimide film according to the first aspect of the present invention, comprising steps of:

flow-casting a polyimide precursor solution (b), which is to be converted into the polyimide layer (b), on a support, followed by drying, thereby preparing a self-supporting film;

coating the self-supporting film, which is to be converted into the polyimide layer (b), with a polyimide precursor solution (a), which is to be converted into the polyimide layer (a); and then

stretching the self-supporting film coated with the polyimide precursor solution (a) in at least one direction while heating it so that the polyimide film obtained has different thermal expansion coefficients between in the MD direction and the TD direction.

There will be described preferred embodiments of the polyimide film according to the first aspect of the present invention, and the process for producing a polyimide film according to the third aspect of the present invention. Two or more of these embodiments may be appropriately combined.

1) The polyimide layer (a) is a layer of a polyimide prepared from a monomer component further comprising an acid component, which comprises at least one selected from the group consisting of pyromellitic dianhydride and 3,3′,4,4′-biphenyltetracarboxylic dianhydride in an amount of from 50 mol % to 100 mol % based on the total molar quantity of the acid component.

2) The polyimide film is prepared by

(i) coating a self-supporting film of a polyimide precursor solution (b), which is to be converted into the polyimide layer (b), with a polyimide precursor solution (a), which is to be converted into the polyimide layer (a); and then stretching or shrinking the film in at least one direction while heating it so that the polyimide film obtained has an anisotropic thermal expansion coefficient; or

(ii) forming a self-supporting film by co-extruding a polyimide precursor solution (b), which is to be converted into the polyimide layer (b), and a polyimide precursor solution (a), which is to be converted into the polyimide layer (a); and then stretching or shrinking the film in at least one direction while heating it so that the polyimide film obtained has an anisotropic thermal expansion coefficient.

3) The polyimide layer (a) is a layer of a polyimide prepared from a monomer component comprising a diamine having the structure of formula (1) in an amount of from 30 mol % to 100 mol % based on the total molar quantity of the diamine component.

4) The diamine having the structure of formula (1) is diaminodiphenyl ether.

5) The thermal expansion coefficient in the MD direction (L_{MD}) and the thermal expansion coefficient in the TD direction (L_{TD}) of the polyimide film satisfy the following inequality: |(L_{MD}−L_{TD})|>5 ppm.

6) The polyimide layer (a) has a thickness of from 0.05 μM to 2 μm.

7) The polyimide film is to be used in the form of a laminate in which a metal layer is laminated directly or via an adhesive layer on the surface of the polyimide layer (a) in the polyimide film.

### Effect of the Invention

The polyimide film of the present invention has an anisotropic thermal expansion coefficient and has a surface with reduced anisotropy of adherence.

According to the present invention, there may be provided a polyimide film which has an anisotropic thermal expansion coefficient and has a surface with reduced anisotropy of adherence.

### DESCRIPTION OF EMBODIMENTS

The thermal expansion coefficient in the MD direction (L_{MD}) and the thermal expansion coefficient in the TD direction (L_{TD}) of the polyimide film of the present invention may preferably satisfy the inequality: |(L_{MD}−L_{TD})|>5 ppm, and more preferably satisfy the inequality: |(L_{MD}−L_{TD})|>6 ppm, and further preferably satisfy the inequality: |(L_{MD}−L_{TD})|>7 ppm, and particularly preferably satisfy the inequality: |(L_{MD}−L_{TD})|>8 ppm.

When the polyimide film of the present invention is to be used, for example, for an IC substrate in which a metal wiring is formed mainly along the MD direction, in particular, the thermal expansion coefficient in the MD direction (L_{MD}) and the thermal expansion coefficient in the TD direction (L_{TD}) of the polyimide film may preferably satisfy the inequality: (L_{MD}−L_{TD})>5 ppm, and more preferably satisfy the inequality: (L_{MD}−L_{TD})>6 ppm, and further preferably satisfy the inequality: (L_{MD}−L_{TD})>7 ppm, and particularly preferably satisfy the inequality: (L_{MD}−L_{TD})>8 ppm, in view of the achievement of remarkable effects.

The term “MD direction” as used herein refers to the casting direction (flow-casting direction, or winding direction, or length direction) and the term “TD direction” as used herein refers to the width direction.

The polyimide layer (a) in the polyimide film of the present invention is a layer of a polyimide which is prepared from an acid component and a diamine component comprising a diamine represented by the following formula (1):

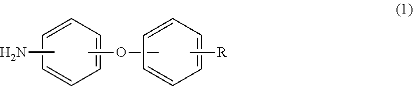

wherein
R represents a monovalent group selected from the groups listed as the following formula (2):

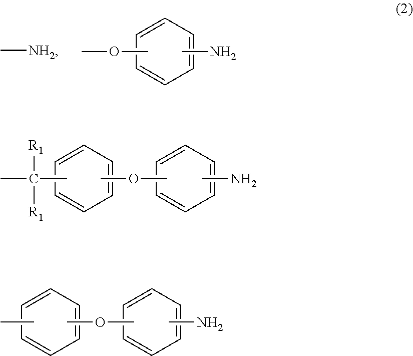

wherein
R₁ represents a hydrogen atom or a methyl group, and two R₁ groups may be the same as, or different from each other.

Examples of the diamine represented by the formula (1) include

1) diaminodiphenyl ethers such as 4,4′-diaminodiphenyl ether, 3,4′-diaminodiphenyl ether and 3,3′-diaminodiphenyl ether;

2) bis(aminophenoxy)benzenes such as 1,3-bis(3-aminophenoxy)benzene, 1,4-bis(3-aminophenoxy)benzene, 1,3-bis(4-aminophenoxy)benzene and 1,4-bis(4-aminophenoxy)benzene;

3) bis(aminophenoxy)biphenyls such as 4,4′-bis(4-aminophenoxy)biphenyl and 4,4′-bis(3-aminophenoxy)biphenyl;

4) bis(aminophenoxy)diphenyl methanes such as 4,4′-bis(4-aminophenoxy)diphenyl methane and 4,4′-bis(3-aminophenoxy)diphenyl methane; and

5) bis(aminophenoxy)diphenyl propanes such as 4,4″bis(4-aminophenoxy)diphenyl propane and 4,4′-bis(3-aminophenoxy)diphenyl propane.

These diamines may be used alone or in combination of two or more.

The diamine represented by the formula (1) may be particularly preferably a diaminodiphenyl ether such as 4,4′-diaminodiphenyl ether, 3,4′-diaminodiphenyl ether and 3,3′-diaminodiphenyl ether.

The polyimide layer (a) may comprise a diamine having the structure of the formula (1) as long as the characteristics of the present invention would not be impaired. Specifically, the polyimide layer (a) may be preferably a layer of a polyimide which is prepared from a monomer component comprising a diamine having the structure of the formula (1) in an amount of from 30 mol % to 100 mol %, more preferably from 50 mol % to 100 mol %, further preferably from 70 mol % to 100 mol %, particularly preferably from 85 mol % to 100 mol %, based on the total molar quantity of the diamine component.

In the present invention, the polyimide (a) to be used is not a “heat-resistant amorphous polyimide” as described in the claims of JP-A-2005-272520; a “thermoplastic polyimide” as described in the claims of JP-A-2003-251773; a “heat-resistant amorphous polyimide” as described in the claims of JP-A-2005-272520; nor a “thermoplastic polyimide” as described in the claims of JP-A-2003-251773.

The polyimide (a) may comprise, in addition to diamine(s) having the structure of the formula (1), other diamine(s), for example, diamines having one or two benzene rings (which do not have an alkyl chain containing two or more carbon atoms such as ethylene chain between the two benzene rings) such as p-phenylenediamine, m-phenylenediamine, 4,4′-diaminodiphenyl methane, o-tolidine, m-tolidine, and 4,4′-diaminobenzanilide, as long as the characteristics of the present invention would not be impaired. These diamines may be used alone or in combination of two or more.

The acid component in the polyimide (a) may be preferably at least one selected from the group consisting of 3,3′,4,4′-biphenyltetracarboxylic dianhydride and pyromellitic dianhydride. The polyimide layer (a) may preferably comprise at least one selected from the group consisting of pyromellitic dianhydride and 3,3′,4,4′-biphenyltetracarboxylic dianhydride in an amount of from 50 mol % to 100 mol % based on the total molar quantity of the acid component.

A preferable combination of an acid component and a diamine component constituting the polyimide (a) may be, for example, a combination of an acid component comprising at least one selected from the group consisting of 3,3′,4,4′-biphenyltetracarboxylic dianhydride, and pyromellitic dianhydride, and a diamine component comprising at least one selected from the group consisting of p-phenylenediamine, 4,4′-diaminodiphenyl ether, and 3,4′-diaminodiphenyl ether.

The polyimide to be used for the polyimide layer (b) may be preferably a heat-resistant polyimide, which forms a base film to be used, for example, as a material for an electronic component such as a printed wiring board, a flexible printed circuit board and a TAB tape, and a reinforced sheet, and the like.

The polyimide layer (b) may have excellent heat resistance, strength and elasticity, and may preferably have excellent flex resistance, if necessary.

The polyimide to be used for the polyimide layer (b) may have at least one of the following features, for example. (Any two or more of these features may be appropriately combined.)

1) In the form of a separate polyimide film, the glass transition temperature is 200° C. or higher, preferably 300° C. or higher, and further preferably, a glass transition temperature is undetectable.

2) The thermal expansion coefficient (50° C. to 200° C.) (MD) is within a range of from 5×10⁻⁶ cm/cm/° C. to 20×10⁻⁶ cm/cm/° C., in particular.

3) The tensile elastic modulus (MD, ASTM-D882) is 300 kg/mm² or more.

4) The polyimide is a non-thermoplastic polyimide.

The polyimide to be used for the polyimide layer (b) may be, for example, a polyimide which is prepared from

(1) an acid component comprising at least one selected from the group consisting of 3,3′,4,4′-biphenyltetracarboxylic dianhydride, pyromellitic dianhydride, and 1,4-hydroquinone dibenzoate-3,3′,4,4′-tetracarboxylic dianhydride in an amount of preferably 70 mol % or more, more preferably 80 mol % or more, further preferably 90 mol % or more, based on the total molar quantity of the acid component, and

(2) a diamine component comprising at least one selected from the group consisting of p-phenylenediamine, 4,4′-diaminodiphenyl ether, m-tolidine, and 4,4′-diaminobenzanilide in an amount of preferably 70 mol % or more, more preferably 80 mol % or more, further preferably 90 mol % or more, based on the total molar quantity of the diamine component.

Preferable examples of the combination of the acid component and the diamine component constituting the polyimide to be used for the polyimide layer (b) include

1) 3,3′,4,4′-biphenyltetracarboxylic dianhydride, and p-phenylenediamine, or p-phenylenediamine and 4,4′-diaminodiphenyl ether;

2) 3,3′,4,4′-biphenyltetracarboxylic dianhydride and pyromellitic dianhydride, and p-phenylenediamine, or p-phenylenediamine and 4,4′-diaminodiphenyl ether;

3) pyromellitic dianhydride, and p-phenylenediamine and 4,4′-diaminodiphenyl ether; and

4) an acid component comprising 3,3′,4,4′-biphenyltetracarboxylic dianhydride as a main component (in an amount of 50 mol % or more, based on the total molar quantity of the acid component) and a diamine component comprising p-phenylenediamine as a main component (in an amount of 50 mol % or more, based on the total molar quantity of the diamine component); which may be suitably used as a material for an electronic component such as a printed wiring board, a flexible printed circuit board and a TAB tape, and exhibit excellent mechanical properties over a wide temperature range, and have long-term heat resistance, high resistance to hydrolysis, a high thermal-decomposition initiation temperature, a low heat shrinkage ratio, a low thermal expansion coefficient, and high flame resistance.

The acid component to be used for the polyimide of the polyimide layer (b) may comprise, in addition to the acid component(s) as described above, other dianhydride component(s) such as 2,3,3′4′-biphenyltetracarboxylic dianhydride, 3,3′,4,4′-benzophenone tetracarboxylic dianhydride, bis(3,4-dicarboxyphenyl)ether dianhydride, bis(3,4-dicarboxyphenyl)sulfide dianhydride, bis(3,4-dicarboxyphenyl)sulfone dianhydride, bis(3,4-dicarboxyphenyl)methane dianhydride, 2,2-bis(3,4-dicarboxyphenyl)propane dianhydride, 2,2-bis(3,4-dicarboxyphenyl)-1,1,1,3,3,3-hexafluoropropane dianhydride, and 2,2-bis[(3,4-dicarboxyphenoxy)phenyl]propane dianhydride, as long as the characteristics of the present invention would not be impaired.

The diamine component to be used for the polyimide of the polyimide layer (b) may comprise, in addition to the diamine component(s) as described above, other diamine component(s) such as m-phenylenediamine, 3,4′-diaminodiphenyl ether, 3,3′-diaminodiphenyl sulfide, 3,4′-diaminodiphenyl sulfide, 4,4′-diaminodiphenyl sulfide, 3,3′-diaminodiphenyl sulfone, 3,4′-diaminodiphenyl sulfone, 4,4′-diaminodiphenyl sulfone, 3,3′-diaminobenzophenone, 4,4′-diaminobenzophenone, 3,4′-diaminobenzophenone, 3,3′-diaminodiphenylmethane, 4,4′-diaminodiphenylmethane, 3,4′-diaminodiphenylmethane, 2,2-di(3-aminophenyl)propane, and 2,2-di(4-aminophenyl)propane, as long as the characteristics of the present invention would not be impaired.

The polyimide film of the present invention has different thermal expansion coefficients in the planar direction, and may be obtained, for example, by stretching the film in at least one direction, or shrinking the film in at least one direction, or stretching and shrinking the film in at least one direction, so that the film obtained has different thermal expansion coefficients in the planar direction. In the production of the polyimide film of the present invention, the film may be stretched or shrunk in any direction. In view of handling and productivity, the film may be preferably stretched or shrunk in the TD direction or in the MD direction.

The thermal expansion coefficient of the polyimide film of the present invention may be appropriately selected depending on the intended use. When the polyimide film of the present invention is to be used for a wiring member or a reinforced sheet, the polyimide film may preferably have a thermal expansion coefficient (50° C. to 200° C.) in at least one direction, preferably in the MD direction or in the TD direction, more preferably in the MD direction, within a range of from 1×10⁻⁶ cm/cm/° C. to 30×10⁻⁶ cm/cm/° C., more preferably from 5×10⁻⁶ cm/cm/° C. to 25×10⁻⁶ cm/cm/° C., particularly preferably from 10×10⁻⁶ cm/cm/° C. to 20×10⁻⁶ cm/cm/° C.

Examples of the process for producing the polyimide film of the present invention include

1) a process comprising

the first step of casting a polyimide precursor solution (b), which is to be converted into the polyimide layer (b), on a support, followed by drying, thereby preparing a self-supporting film; and then coating the self-supporting film with a polyimide solution (a) or a polyimide precursor solution (a), which is to be converted into the polyimide layer (a); and

the second step of stretching the coated film in at least one direction and heating the film to effect imidization; and

2) a process comprising

the first step of casting a polyimide solution (b) or a polyimide precursor solution (b), which is to be converted into the polyimide layer (b), and a polyimide solution (a) or a polyimide precursor solution (a), which is to be converted into the polyimide layer (a), on a support by co-extrusion using a die and the like, followed by drying, thereby preparing a self-supporting film; and

the second step of stretching the self-supporting film in at least one direction and heating the film, if necessary, to effect imidization.

According to the present invention, in the case of a long polyimide film, although the polyimide film may be wound into a roll with the side which was in contact with a support when casting either outward or inward, the polyimide film may be preferably wound into a roll with the side which was in contact with a support when casting outward, in view of the simplification of the process.

In the first step, the thin film may be heated for drying in a casting oven at a temperature at which imidization of the polyimide precursor(s) do not fully proceed and a part of or most of the organic solvent(s) are removed from the thin film, until the film is capable of being peeled from the support, to provide a self-supporting film which may be stretched in the length direction or in the width direction while heating in the second step.

One example of the process for producing a self-supporting film, which is prepared by casting a polyimide precursor solution on a support, followed by drying, in the first step is as follows.

Using a film-forming machine equipped with a single-layer or multi-layer extrusion die, a solution of a polyimide precursor in a solvent, or two or more solutions of polyimide precursors in solvents are fed to the die, and then extruded from the outlet (lip) of the die onto a support (endless belt, drum and the like) in the form of a single-layer or multi-layer thin film, to provide a thin film of the solution(s) of the polyimide precursor(s) in the solvent(s) having a substantially uniform thickness. And then, in a casting oven, while moving the support (endless belt, drum and the like), the thin film is heated at a temperature at which imidization of the polyimide precursor(s) do not fully proceed and a part of or most of the organic solvent(s) are removed from the thin film, preferably at a temperature of from 50° C. to 210° C., more preferably from 60° C. to 200° C., to gradually remove the solvent(s) from the thin film until the film becomes self-supporting for pre-drying. And then, the self-supporting film thus obtained is peeled from the support.

The self-supporting film which is obtained in the first step and stretched may preferably have a solvent content of from 25 wt % to 45 wt %, more preferably from 27 wt % to 43 wt %, further preferably from 30 wt % to 41 wt %, particularly preferably from 31 wt % to 40 wt %, and an imidization rate of from 5% to 40%, more preferably from 5.5% to 35%, further preferably from 6.0% to 30%, further preferably from 10% to 28%, particularly preferably from 15% to 27%, because more remarkable effects may be achieved.

The solvent content (weight loss on heating) of a self-supporting film as described above is calculated by the following formula from the weight of the film of interest before drying (W1) and the weight of the film after drying at 400° C. for 30 min (W2).

Weight loss on heating(wt %)={(W1−W2)/W1}×100

The imidization rate of a self-supporting film as described above may be calculated based on the ratio of the vibration band peak area between the self-supporting film and a fully-cured product, which are measured with an IR spectrometer (ATR). The vibration band peak utilized in the procedure may be a symmetric stretching vibration band of an imide carbonyl group and a stretching vibration band of a benzene ring skeleton. The imidization rate may be also determined in accordance with the procedure described in JP-A-H09-316199, using a Karl Fischer moisture meter.

In the self-supporting film which is prepared by flow-casting a polyimide precursor solution (e.g. polyamic acid solution) on a support (e.g. stainless specular surface and belt surface) followed by drying, the side which has been in contact with the support is taken as side B of the self-supporting film; while the side which has been in contact with air, opposite to the support, is taken as side A of the self-supporting film.

One preferable example of the process for forming a polyimide layer (a) on a self-supporting film of a polyimide layer (b) in the first step is as follows.

A polyimide solution (a) or a polyimide precursor solution (a) is evenly applied and distributed onto one side (side A or side B) of the self-supporting film which is peeled from the support, by a coating method such as gravure coating, screen coating and dip coating, to provide a polyimide layer (a), preferably a polyimide layer (a) having a thickness of from 0.1 μm to 2 μm. And then, the coated film is dried, preferably at a temperature of from 50° C. to 180° C., particularly preferably from 60° C. to 160° C., further preferably from 70° C. to 150° C., preferably for from 0.1 min to 20 min, particularly preferably from 0.2 min to 15 min, to provide a solidified film. And then, the solidified film is dried, preferably at a temperature of from about 80° C. to about 250° C., particularly preferably from 100° C. to 230° C., preferably for from about 1 min to about 200 min, particularly preferably from 2 min to 100 min, in a state in which the film is free (not fixed) or under a low tension, preferably 100 gf/mm² or lower, particularly preferably 80 gf/mm² or lower, to provide a solidified film which contains an organic solvent and water, which has formed, in an amount of from about 5 wt % to about 25 wt %, particularly from 10 wt % to 23 wt %.

The support on which a polyimide solution or a polyimide precursor solution is cast in the first step may be formed from any known material. The support may preferably have a surface made of metal such as stainless steel or resin such as polyethylene terephthalate. Examples of the support include a stainless belt, a stainless roll, and a polyethylene terephthalate belt.

The support may preferably have a surface on which a uniform thin film of a solution is formed.

The support may particularly preferably have a smooth surface, although the support may have a groove and/or emboss in the surface.

The self-supporting film which is peeled from the support in the first step may preferably contain a solvent, in view of the easiness of stretching.

In the first step, a polyimide precursor solution (a) or a polyimide solution (a), which is to be converted into the polyimide (a), may be applied onto one side or both sides of the self-supporting film by any known coating method, which includes, for example, gravure coating, spin coating, silk screen coating, dip coating, spray coating, bar coating, knife coating, roll coating, blade coating, and die coating.

In the second step, the whole of or a part of operation or treatment such as the stretching or shrinking of the self-supporting film, and the heating of the self-supporting film may be preferably conducted while fixing both edges of the film in the width direction by means of a pin tenter, a clip tenter or a chuck tenter, for example.

In the production of the polyimide film of the present invention, the film may be stretched according to any known method so as to achieve a desired thermal expansion coefficient and desired properties. The stretch ratio may be appropriately selected, for example, within a range of from 0.7 to 1.9, preferably from 0.8 to 1.7, more preferably from 0.9 to 1.5, further preferably from 1.01 to 1.12.

In the case of a self-supporting film which is formed by coating or co-extrusion, in particular, the stretch ratio may be preferably within a range of from 1.01 to 1.12, more preferably from 1.04 to 1.11, further preferably from 1.05 to 1.10, further preferably from 1.06 to 1.10, particularly preferably from 1.07 to 1.09.

As an example of stretching, a film may be shrunk or stretched by moving at least one of two tenter members (or elements) and the like, with which both edges of the film are fixed. As another example of stretching, a film may be shrunk or stretched by controlling the roll speed, the tension between rolls, and the like in the continuous production process. The stretching may be preferably conducted while heating the film.

Although the stretching of the film is conducted in the second step, the stretching of the film may be conducted in the first step.

The heat treatment in a casting oven in the first step, and heat treatment in the second step may be conducted by heating the film in a plurality of heating blocks (zones) having various temperatures, in other words, may be conducted using a casting oven comprising a plurality of heating blocks having various temperatures, and a heating apparatus such as a heating oven comprising a plurality of heating blocks having various temperatures.

In the second step, the stretch speed of the self-supporting film in the MD direction or in the TD direction may be appropriately selected so as to achieve desired properties, including desired thermal expansion coefficient. The self-supporting film may be preferably stretched at a speed of from 1%/min to 20%/min, more preferably from 2%/min to 10%/min.

As for the pattern for the stretching of the self-supporting film, the self-supporting film may be instantaneously stretched, or stretched step-by-step, or gradually stretched at a variable speed, or gradually stretched at a constant speed from the stretch ratio 1 to the desired stretch ratio, or a combination of two or more of these patterns may be also employed. The self-supporting film may be preferably stretched gradually at a constant speed.

The heating time for the stretching of the self-supporting film in the second step may be appropriately selected depending on a apparatus to be used, and the like, and may be preferably from 1 min to 60 min.

In the second step, the self-supporting film should be stretched within a temperature range in which the self-supporting film may be stretched without any trouble.

In the second step, the self-supporting film may be heated at a temperature in which imidization fully, or substantially fully proceeds. The self-supporting film may be preferably heated at a temperature of from 350° C. to 600° C., preferably from 450° C. to 590° C., more preferably from 490° C. to 580° C., further preferably from 500° C. to 580° C., particularly preferably from 520° C. to 580° C., as the final heating temperature, for from 1 min to 30 min.

The above-mentioned heat treatment may be conducted using any known heating apparatus such as a hot-air oven and an infrared oven.

In the second step, the self-supporting film may be preferably heated in an inert gas atmosphere such as nitrogen gas, and argon gas or in a heated gas atmosphere such as air.

The polyimide film of the present invention may be preferably subjected to a heat treatment at a temperature of from 350° C. to 600° C., preferably from 450° C. to 590° C., more preferably from 490° C. to 580° C., further preferably from 500° C. to 580° C., particularly preferably from 520° C. to 580° C., when the polyimide film is to be used as a material for an electronic component such as a printed wiring board, a flexible printed circuit board, and a TAB tape, or a reinforced sheet, for example.

The thickness of the polyimide film of the present invention may be appropriately selected depending on the intended use, and may be, but not limited to, from about 5 μm to about 154 μm, preferably from about 5 μm to about 150 μm.

In the polyimide film of the present invention, the thicknesses of the polyimide layer (b) as a base and the polyimide layer (a) as a surface layer may be appropriately selected depending on the intended use.

The thickness of the polyimide layer (b) may be preferably from 5 pan to 150 μm, more preferably from 8 μm to 120 μm, further preferably from 10 μm to 100 μm, particularly preferably from 20 μm to 50 μm.

The polyimide layer (a) may have such a thickness that the polyimide film may exhibit no or reduced anisotropy of adherence in the surface. The thickness of the polyimide layer (a) may be preferably from 0.05 μm to 2 μm, more preferably from 0.06 μm to 1.5 μm, further preferably from 0.07 μm to 1 μm, particularly preferably from 0.1 μm to 0.8 μm. When the thickness of the polyimide layer (a) is preferably from 0.05 μm to 1 μm, more preferably from 0.06 μm to 0.8 μm, further preferably from 0.07 μm to 0.5 μm, particularly preferably from 0.08 μm to 0.2 μm, the obtained polyimide film may be a heat-resistant film, and a chip may be mounted on a metal-laminated polyimide film, which is prepared by forming a metal layer directly on the surface of the polyimide layer (a), at a high temperature with Au—Au connection or Au—Sn connection without embedding a metal wiring in the polyimide layer.

According to the present invention, a polyimide film may be prepared by methods other than thermal imidization; by chemical imidization, or a combination of thermal imidization and chemical imidization.

The polyimide film may be preferably produced by thermal imidization in order to form a self-supporting film having a solvent content within the above-mentioned range and/or an imidization rate within the above-mentioned range, which have the advantage in stretching.

A polyimide precursor may be synthesized by any known method; for example, by random-polymerizing or block-polymerizing substantially equimolar amounts of an acid component such as an aromatic tetracarboxylic dianhydride and a diamine component in an organic solvent. Alternatively, two or more polyimide precursors in which either of these two components is excessive may be prepared, and subsequently, these polyimide precursor solutions may be combined and then mixed under reaction conditions. The polyimide precursor solution thus obtained may be used without any treatment, or alternatively, after removing or adding a solvent, if necessary, to prepare a self-supporting film.

There are no particular restrictions to the polyimide precursor solution (b), so long as it may be cast on a support and converted into a self-supporting film which may be peeled from the support and be stretched in at least one direction. The type, polymerization degree and concentration of the polymer, and the type and concentration of an additive which may be added to the solution, if necessary, and the viscosity of the solution may be appropriately selected.

A polyimide solution may be prepared by any known method.

Any known polymerization solvent may be used as an organic polar solvent for use in the production of the polyimide precursor solution, or the polyimide solution. Examples of the solvent include amides such as N-methyl-2-pyrrolidone, N,N-dimethylacetamide, N,N-diethylacetamide, N,N-dimethylformamide, N,N-diethylformamide and hexamethylsulforamide; sulfoxides such as dimethylsulfoxide and diethylsulfoxide; and sulfones such as dimethylsulfone and diethylsulfone. These solvents may be used alone or in combination of two or more.

The polyimide precursor solution may contain an imidization catalyst, an organic phosphorous-containing compound, a fine particle such as an inorganic fine particle and an organic fine particle, a dehydrating agent, and the like, if necessary.

The polyimide solution may contain an organic phosphorous-containing compound, a fine particle such as an inorganic fine particle and an organic fine particle, and the like, if necessary.

In the case of the polyimide solution (b) and polyimide precursor solution (b) to be used for a base, the concentration of all monomers in the organic polar solvent may be preferably within a range of from 5 wt % to 40 wt %, more preferably from 6 wt % to 35 wt %, particularly preferably from 10 wt % to 30 wt %. In the case of the polyimide precursor solution (a) and polyimide solution (a) to be used for a surface layer, the concentration of all monomers in the organic polar solvent may be preferably within a range of from 1 wt % to 15 wt %, particularly preferably from 2 wt % to 8 wt %.

The polyimide solution (a) or the polyimide precursor solution (a) may be prepared by diluting a polymer solution previously prepared, which has a high monomer concentration, with a solvent.

One example of the process for producing a polyimide precursor is as follows. The polymerization reaction of an acid component such as an aromatic tetracarboxylic dianhydride and an aromatic diamine component may be conducted, for example, by mixing these components in a substantially equimolar ratio, or in a little excess ratio of either one component (an acid component or a diamine component) at a reaction temperature of 100° C. or lower, preferably at a temperature of from 0° C. to 80° C., more preferably from 10° C. to 50° C., for from about 0.2 hours to about 60 hours for reaction, to provide a polyamic acid (polyimide precursor) solution.

In the polymerization reaction of the polyimide (b) and polyimide precursor (b), the solution viscosity may be appropriately selected depending on the intended use (cast, extrusion, etc.) and the purpose of the production. The rotational viscosity, which is measured at a temperature of 30° C., may be preferably within a range of from about 100 poise to about 10000 poise, more preferably from 400 poise to 5000 poise, particularly preferably from 1000 poise to 3000 poise. Accordingly, the polymerization reaction may be preferably conducted to the extent that the desired solution viscosity is achieved.

In the polymerization reaction of the polyimide (a) and polyimide precursor (a), the solution viscosity may be appropriately selected depending on the intended use (cast, extrusion, etc.) and the purpose of the production. The rotational viscosity, which is measured at a temperature of 30° C., may be preferably within a range of from about 0.1 poise to about 5000 poise, more preferably from 0.5 poise to 2000 poise, particularly preferably from 1 poise to 2000 poise. Accordingly, the polymerization reaction may be preferably conducted to the extent that the desired solution viscosity is achieved.

Examples of the imidization catalyst include substituted or unsubstituted nitrogen-containing heterocyclic compounds, N-oxide compounds of the nitrogen-containing heterocyclic compounds, substituted or unsubstituted amino acid compounds, hydroxyl-containing aromatic hydrocarbon compounds, and aromatic heterocyclic compounds. Particularly preferable examples of the imidization catalyst include lower-alkyl imidazoles such as 1,2-dimethylimidazole, N-methylimidazole, N-benzyl-2-methylimidazole, 2-methylimidazole, 2-ethyl-4-methylimidazole and 5-methylbenzimidazole; benzimidazoles such as N-benzyl-2-methylimidazole; and substituted pyridines such as isoquinoline, 3,5-dimethylpyridine, 3,4-dimethylpyridine, 2,5-dimethylpyridine, 2,4-dimethylpyridine and 4-n-propylpyridine. The amount of the imidization catalyst to be used is preferably about 0.01 to 2 equivalents, particularly preferably about 0.02 to 1 equivalents relative to the amide acid unit in a polyamide acid. When the imidization catalyst is used, the polyimide film obtained may have improved properties, particularly extension and edge-cracking resistance.

Examples of the organic phosphorous-containing compound include phosphates such as monocaproyl phosphate, monooctyl phosphate, monolauryl phosphate, monomyristyl phosphate, monocetyl phosphate, monostearyl phosphate, triethyleneglycol monotridecyl ether monophosphate, tetraethyleneglycol monolauryl ether monophosphate, diethyleneglycol monostearyl ether monophosphate, dicaproyl phosphate, dioctyl phosphate, dicapryl phosphate, dilauryl phosphate, dimyristyl phosphate, dicetyl phosphate, distearyl phosphate, tetraethyleneglycol mononeopentyl ether diphosphate, triethyleneglycol monotridecyl ether diphosphate, tetraethyleneglycol monolauryl ether diphosphate, and diethyleneglycol monostearyl ether diphosphate; and amine salts of these phosphates. Examples of the amine include ammonia, monomethylamine, monoethylamine, monopropylamine, monobutylamine, dimethylamine, diethylamine, dipropylamine, dibutylamine, trimethylamine, triethylamine, tripropylamine, tributylamine, monoethanolamine, diethanolamine and triethanolamine.

Examples of the particle include organic particles and inorganic particles.

Examples of the organic particle include particles of organic materials which are insoluble in the polyimide solution and the polyimide precursor solution; specifically particles of polymer compounds such as particles of polyimides and particles of aramids, and particles of cross-linked resins such as epoxy resins.

Examples of the inorganic fine particle include particulate inorganic oxide powders such as titanium dioxide powder, silicon dioxide (silica) powder, magnesium oxide powder, aluminum oxide (alumina) powder and zinc oxide powder; particulate inorganic nitride powders such as silicon nitride powder and titanium nitride powder; inorganic carbide powders such as silicon carbide powder; and particulate inorganic salt powders such as calcium carbonate powder, calcium sulfate powder and barium sulfate powder. These inorganic fine particles may be used in combination of two or more. These inorganic fine particles may be homogeneously dispersed using the known means.

The polyimide film of the present invention may be used without any treatment, or may be used after subjecting the polyimide layer (a) or the polyimide layer (b) to surface treatment such as corona discharge treatment, low-temperature plasma discharge treatment, atmospheric-pressure plasma discharge treatment, and chemical etching, as necessary.

The polyimide film of the present invention has improved adhesiveness, and therefore a polyimide film having an adhesive, a photosensitive material, a thermocompression-bondable material and the like thereon may be obtained.

The polyimide film of the present invention has improved adhesiveness, sputtering properties, and metal vapor deposition properties. Therefore, a metal foil such as a copper foil may be attached onto the polyimide film with an adhesive, to give a metal-laminated polyimide film such as a copper-laminated polyimide film having excellent adhesiveness and sufficiently high peel strength. Alternatively, a metal layer such as a copper layer may be formed on the polyimide film by a metallizing method such as sputtering and metal vapor deposition, to give a metal-laminated polyimide film such as a copper-laminated polyimide film having excellent adhesiveness and sufficiently high peel strength.

In addition, a metal foil such as a copper foil may be laminated on the polyimide film obtained according to the present invention using a thermocompression-bondable polymer such as a thermocompression-bondable polyimide, to give a metal foil-laminated polyimide film. A metal layer may be laminated on a polyimide film by a known method.

The type and thickness of a metal foil, which is attached onto the polyimide film with an adhesive, may be appropriately selected depending on the intended use. Specific examples of the metal foil include a rolled copper foil, an electrolytic copper foil, a copper alloy foil, an aluminum foil, a stainless foil, a titanium foil, an iron foil and a nickel foil. The thickness of the metal foil may be preferably from about 1 μm to about 50 μm, more preferably from about 2 μm to about 20 μm. A metal foil having a thickness of about 5 μm or less may be preferably used in the form of a foil with a carrier.

Another resin film, a metal such as copper, a chip member such as an IC chip, or the like may be attached onto the polyimide film of the present invention with an adhesive.

Any known adhesive, including an adhesive having excellent insulating properties and excellent adhesion reliability, or an adhesive having excellent conductivity and excellent adhesion reliability such as an ACF, which is bonded by pressure, may be used, depending on the intended use. A thermoplastic adhesive or a thermosetting adhesive may be also used.

Examples of the adhesive include polyimide adhesives, polyamide adhesives, polyimide-amide adhesives, acrylic adhesives, epoxy adhesives, urethane adhesives, and adhesives containing two or more thereof. An acrylic adhesive, an epoxy adhesive, a urethane adhesive, or a polyimide adhesive may be particularly suitably used.

The metallizing method is a method for forming a metal layer, which is different from metal plating or metal foil lamination, and any known method such as vapor deposition, sputtering, ion plating and electron-beam evaporation may be employed.

Examples of a metal to be used in the metallizing method include, but not limited to, metals such as copper, nickel, chromium, manganese, aluminum, iron, molybdenum, cobalt, tungsten, vanadium, titanium and tantalum, and alloys thereof, and metal compounds such as oxides and carbides of these metals. A thickness of a metal layer formed by a metallizing method may be appropriately selected depending on the intended use, and may be preferably from 1 nm to 500 nm, more preferably from 5 nm to 200 nm for a practical use. The number of metal layers formed by a metallizing method may be appropriately selected depending on the intended use, and may be one, two, three or more layers.

A metal-plated layer such as a copper-plated layer and a tin-plated layer may be formed by a known wet plating process such as electrolytic plating and electroless plating on the surface of the metal layer of the metal-laminated polyimide film, which is produced by a metallizing method. The thickness of the metal-plated layer such as a copper-plated layer may be preferably from 1 μm to 40 μm for a practical use.

According to the present invention, a copper-laminated polyimide film having a 90° peel strength of 0.3 N/mm or higher, further 0.4 N/mm or higher, particularly 0.5 N/mm or higher, for example, may be obtained without using a coupling agent for the production of a polyimide film.

The polyimide film of the present invention may be suitably used as an insulating substrate material for FPC, TAB, COF, a metal-wiring board and the like, a cover material for a metal wiring, a chip such as an IC chip and the like, and a base material for a liquid crystal display, an organic electroluminescent display, an electronic paper, a solar cell and the like.

The metal layer on one side or both sides of the polyimide-metal laminate of the present invention may be partially removed by any known method, for example, by etching, to provide a wiring member having a metal wiring formed on the film.

The wiring member may preferably have most of the metal wirings, or the metal wirings to be connected to an IC chip, or the metal wirings on the periphery thereof, which are formed along the direction perpendicular to the stretching direction, in view of the greater precision in thermal expansion.

At least one chip member such as an IC chip may be mounted on, or connected to the wiring member for use.

A covering member which covers other wirings may be laminated on the wiring member for use.

Examples of the chip member such as an IC chip include any known chip member, for example, semiconductor chips such as a silicon chip, and semiconductor chips of various functions such as for liquid crystal display driver, for system and for memory.

A resistor, a capacitor, and the like, in addition to a metal layer, may be mounted on the polyimide film of the present invention.

A polyimide-metal laminate produced using a polyimide film, which is produced by the production process of the present invention and has a thermal expansion coefficient in the width direction lower than in the length direction, may be suitably used for a wiring member having a metal wiring at least along the direction of the length.

A wiring member may be produced by forming a metal layer on a polyimide film, which is produced by the production process of the present invention and has a thermal expansion coefficient in the width direction lower than in the length direction; and then removing a part of the metal layer to form a metal wiring mainly along the direction of the length. The polyimide film of the present invention may be particularly suitably used for connecting to an IC chip or a glass substrate.

### EXAMPLES

The present invention will be described in more detail below with reference to the Examples. However, the present invention is not limited to these Examples.

The properties of a self-supporting film and a polyimide film were evaluated as follows.

1) Method of measuring the solvent content of a self-supporting film

A self-supporting film was heated at 400° C. for 30 min in an oven. The solvent content of the self-supporting film was calculated from the weight of the film before the heat treatment (W1) and the weight of the film after the heat treatment (W2) by the following formula (1).

Solvent content(%)=(W1−W2)/W1×100 (1)

2) Method of measuring the imidization rate of a self-supporting film

IR-ATR spectra of a self-supporting film and the fully-imidized film thereof were measured with a ZnSe, using FT-IR-4100 made by Jasco Corporation. The peak areas in the range of 1560.13 cm⁻¹ to 1432.85 cm⁻¹ were measured as X1, and the peak areas in the range of 1798.30 cm⁻¹ to 1747.19 cm⁻¹ were measured as X2. The imidization rate of the self-supporting film was calculated from the area ratio (X1/X2) of the self-supporting film and the area ratio (X1/X2) of the fully-imidized film by the following formula (2). The measurements were carried out on both sides of the films, and an average value of the both sides was defined as the imidization rate. (The peak areas were measured using a software installed in the measuring instrument.)

The fully-imidized film was prepared by heating the self-supporting film at 480° C. for 5 min. The support side when the polyimide precursor solution was cast on the support was taken as side A of the film, while the gas side was taken as side B of the film.

Imidization rate of a self-supporting film(%)=(a1/a2+b1/b2)×50 (2)

wherein
a1 represents the area ratio (X1/X2) of side A of the self-supporting film;
b1 represents the area ratio (X1/X2) of side B of the self-supporting film;
a2 represents the area ratio (X1/X2) of side A of the fully-imidized film; and
b2 represents the area ratio (X1/X2) of side B of the fully-imidized film;
wherein
X1 represents the peak areas in the range of 1560.13 cm⁻¹ to 1432.85 cm⁻¹; and
X2 represents the peak areas in the range of 1798.30 cm⁻¹ to 1747.19 cm⁻¹.

3) Method of measuring the thermal expansion coefficient (thermal expansion coefficient in the width direction)

The average thermal expansion coefficient from 50° C. to 200° C. was measured, using TMA/SS6100 made by Seiko Instruments Inc., when the polyimide film was heated at the rate of 20° C./min.

4) Peel strength (90° Peel Strength)

The 90° peel strength was measured in an air-conditioned atmosphere at 23° C., using a sample piece with a width of 2-10 mm, in accordance with JIS C6471, Method A for strength of peeling a copper foil.

### Reference Example 1

### Preparation of Polyimide Precursor Solution for a Base

Equimolar amounts of 3,3′,4,4′-biphenyltetracarboxylic dianhydride (s-BPDA) and p-phenylenediamine (PPD) were polymerized at 30° C. for 3 hours in N,N-dimethylacetamide, to give a polyamic acid solution having a concentration of 18 wt %. To the polyamic acid solution were added 0.1 parts by weight of triethanolamine salt of monostearyl phosphate, and then 0.5 parts by weight of silica filler (average particle size: 0.08 μm, ST-ZL made by Nissan Chemical Industries, Ltd.) relative to 100 parts by weight of the polyamic acid. The resulting mixture was homogeneously mixed, to give a polyimide precursor solution (X).

### Reference Example 2

### Preparation of Polyimide Precursor Solution for Surface Coating

Equimolar amounts of 3,3′,4,4′-biphenyltetracarboxylic dianhydride and 4,4′-diaminodiphenyl ether (DADE) were polymerized at 30° C. for 3 hours in N,N-dimethylacetamide, to give a polyamic acid solution having a concentration of 3.0 wt %. To the polyamic acid solution was added 0.5 parts by weight of silica filler (average particle size: 0.08 μm, ST-ZL made by Nissan Chemical Industries, Ltd.) relative to 100 parts by weight of the polyamic acid. The resulting mixture was homogeneously mixed, to give a polyimide precursor solution (Y).

### Example 1

### Preparation of Stretched Polyimide Film

The polyimide precursor solution (X) of Reference Example 1, which was prepared as a dope for a base film, was continuously cast on a stainless substrate (support) so that the thickness of the film was 35 μm after heating/drying, and then dried under hot air at 140° C. and peeled off from the support, to form a self-supporting film. Subsequently, the polyimide precursor solution (Y) of Reference Example 2 was applied, by means of a die coater, on a side of the self-supporting film which had been in contact with the support, so that the thickness of the layer was 0.5 μm after drying. After coating, the self-supporting film was gradually heated from 200° C. to 575° C. in a heating oven for solvent removal and imidization, while the self-supporting film was stretched in the width direction at a stretch ratio of 7%, to give a stretched polyimide film. The thermal expansion coefficient of the stretched polyimide film was measured, and the result is shown in Table 1. The stretched polyimide film was continuously produced.

The self-supporting film had a solvent content of 32 wt % and an imidization rate of 25%.

(Formation of Metal Layer by Metallizing Method)

The surface of the stretched polyimide film, on which the polyimide precursor solution had been applied, was cleaned by plasma treatment. And then, as a metal layer, a nickel-chrome alloy layer having a chrome content of 15 wt % and a thickness of 5 nm was formed on the cleaned surface by sputtering. Subsequently, a copper layer having a thickness of 300 nm was formed on the nickel-chrome alloy layer by sputtering. And then, a copper-plated layer having a thickness of 20 μm was formed on the metal layer by electrolytic copper plating, to give a copper-plating laminated polyimide film. The adhesion strength (90° peel strength) between the copper-plated layer and the polyimide of the copper-plating laminated polyimide film was measured, and the result is shown in Table 1.

### Comparative Example 1

A stretched polyimide film was prepared in the same way as in Example 1, except that 3 wt % solution of γ-phenylaminopropyl trimethoxy silane in N,N-dimethylacetamide, which contained no polyimide precursor, was applied on a side of the self-supporting film in an amount of 7 g/m², instead of applying the polyimide precursor solution (Y) of Reference Example 2. The thermal expansion coefficient of the stretched polyimide film was measured, and the result is shown in Table 1.

A copper-plated layer was formed on the surface of the stretched polyimide film obtained in the same way as in Example 1, to give a copper-plating laminated polyimide film. The adhesion strength (90° peel strength) of the copper-plating laminated polyimide film was measured in the same way as in Example 1, and the result is shown in Table 1.

### Reference Example 1

The polyimide precursor solution (X) of Reference Example 1, which was prepared as a dope for a base film, was continuously cast on a stainless substrate (support) so that the thickness of the film was 35 μm after heating/drying, and then dried under hot air at 140° C. and peeled off from the support, to form a self-supporting film. Subsequently, 3 wt % solution of γ-phenylaminopropyl trimethoxy silane in N,N-dimethylacetamide, which contained no polyimide precursor, was applied in an amount of 7 g/m², by means of a die coater, on a side of the self-supporting film which had been in contact with the support, and then the self-supporting film was dried. After coating, the self-supporting film was gradually heated from 200° C. to 575° C. in a heating oven for solvent removal and imidization, to give an unstretched polyimide film. The thermal expansion coefficient of the unstretched polyimide film was measured, and the result is shown in Table 1. The unstretched polyimide film was continuously produced.

A copper-plated layer was formed on the surface of the unstretched polyimide film obtained in the same way as in Example 1, to give a copper-plating laminated polyimide film. The adhesion strength (90° peel strength) of the copper-plating laminated polyimide film was measured in the same way as in Example 1, and the result is shown in Table 1.

TABLE 1

| | | | | Polyimide film | | | Copper-plating laminated | |
|---|---|---|---|---|---|---|---|---|
| | Coating solution | | | | Thermal expansion | | polyimide film | |
| | Acid | Diamine | Surface | Film | coefficient (ppm/° C.) | | 90° peel strength (N/mm) | |
| | component | component | treatment agent | stretching | MD | TD | MD | TD |
| Reference | — | — | Contained | Not conducted | 13 | 13 | 0.81 | 0.76 |
| Example 1 | | | | | | | | |
| Comparative | — | — | Contained | Conducted | 15 | 5 | 0.89 | 0.71 |
| Example 1 | | | | | | | | |
| Example 1 | s-BPDA | DADE | Not contained | Conducted | 15 | 5 | 0.82 | 0.74 |

As can be seen from Table 1, in the polyimide film of Reference Example 1, the thermal expansion coefficients in the MD direction (L_{MD}) and in the TD direction (L_{TD}) satisfied the equation: (L_{MD}−L_{TD})=0 ppm, whereas in the polyimide films of Example 1 and Comparative Example 1, the thermal expansion coefficients in the MD direction (L_{MD}) and in the TD direction (L_{TD}) satisfied the equation: (L_{MD}−L_{TD})=10 ppm.

As compared with Reference Example 1, the copper-plating laminated polyimide film of Comparative Example 1, which had greater difference in thermal expansion coefficient, had greater difference in 90° peel strength between in the MD direction and in the TD direction. As compared with Comparative Example 1, the copper-plating laminated polyimide film of Example 1 had smaller difference in 90° peel strength between in the MD direction and in the TD direction, and had reduced anisotropy of adherence.

In addition, in Example 1, a metal layer exhibiting excellent adherence to the polyimide film was formed by a metallizing method, without using a surface treatment agent.

1-11. (canceled)

12. A polyimide film for metallizing, having an anisotropic thermal expansion coefficient, and comprising a polyimide layer (b) and a polyimide layer (a) on one side or both sides of the polyimide layer (b), wherein
the polyimide layer (a) is a layer of a polyimide prepared from a monomer component comprising a diamine having the structure of the following formula (1): 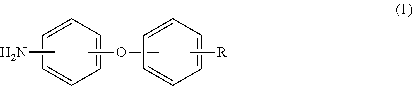
wherein
R represents a monovalent group selected from the groups listed as the following formula (2): 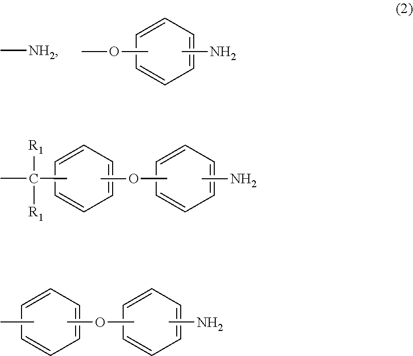
wherein
R₁ represents a hydrogen atom or a methyl group, and two R₁ groups may be the same as, or different from each other.

13. The polyimide film as claimed in claim 12, wherein the monomer component for the polyimide layer (a) further comprises an acid component comprising at least one selected from the group consisting of pyromellitic dianhydride and 3,3′,4,4′-biphenyltetracarboxylic dianhydride in an amount of from 50 mol % to 100 mol % based on the total molar quantity of the acid component.

14. The polyimide film as claimed in claim 12, wherein the polyimide film is prepared by
(i) coating a self-supporting film of a polyimide precursor solution (b), which is to be converted into the polyimide layer (b), with a polyimide precursor solution (a), which is to be converted into the polyimide layer (a); and then stretching or shrinking the film in at least one direction while heating it so that the polyimide film obtained has an anisotropic thermal expansion coefficient; or
(ii) forming a self-supporting film by co-extruding a polyimide precursor solution (b), which is to be converted into the polyimide layer (b), and a polyimide precursor solution (a), which is to be converted into the polyimide layer (a); and then stretching or shrinking the film in at least one direction while heating it so that the polyimide film obtained has an anisotropic thermal expansion coefficient.

15. The polyimide film as claimed in claim 12, wherein the polyimide layer (a) is a layer of a polyimide prepared from a monomer component comprising a diamine having the structure of formula (1) in an amount of from 30 mol % to 100 mol % based on the total molar quantity of the diamine component.

16. The polyimide film as claimed in claim 12, wherein the diamine having the structure of formula (1) is diaminodiphenyl ether.

17. The polyimide film as claimed in claim 12, wherein the thermal expansion coefficient in the MD direction (L_{MD}) and the thermal expansion coefficient in the TD direction (L_{TD}) satisfy the following inequality: |(L_{MD}−L_{TD})|>5 ppm.

18. The polyimide film as claimed in claim 12, wherein the polyimide layer (a) has a thickness of from 0.05 μm to 2 μm.

19. The polyimide film as claimed in claim 12, wherein the polyimide film is to be used in the form of a laminate in which a metal layer is formed by a metallizing method on the surface of the polyimide layer (a).

20. A metal-laminated polyimide film, comprising a polyimide film as claimed in claim 12, and a metal layer which is formed by a metallizing method on the surface of the polyimide layer (a) of the polyimide film.

21. A process for producing a polyimide film as claimed in claim 12, comprising steps of:
flow-casting a polyimide precursor solution (b), which is to be converted into the polyimide layer (b), on a support, followed by drying, thereby preparing a self-supporting film;
coating the self-supporting film, which is to be converted into the polyimide layer (b), with a polyimide precursor solution (a), which is to be converted into the polyimide layer (a); and then
stretching the self-supporting film coated with the polyimide precursor solution (a) in at least one direction while heating it so that the polyimide film obtained has different thermal expansion coefficients between in the MD direction and the TD direction.

22. A metal-plating laminated polyimide film, comprising a metal-laminated polyimide film as claimed in claim 20, and a metal-plated layer which is formed by a metal plating method on the metal layer of the metal-laminated polyimide film.
